(19) United States
(12) Patent Application Publication
(10) Pub. No.: US 2020/0032669 A1
(43) Pub. Date: Jan. 30, 2020

(54) SHROUDED BLADE ASSEMBLIES

(71) Applicant: UNITED TECHNOLOGIES CORPORATION, Farmington, CT (US)

(72) Inventor: Steven D. Roberts, Moodus, CT (US)

(73) Assignee: UNITED TECHNOLOGIES CORPORATION, Farmington, CT (US)

(21) Appl. No.: 16/043,413

(22) Filed: Jul. 24, 2018

(51) Int. Cl. F01D 11/02; F01D 5/22; F01D 5/14; F01D 11/08; F02K 3/02; F04D 29/16; F04D 29/32

(52) U.S. Cl. CPC F01D 11/02; F01D 5/225; F01D 5/141; F01D 11/08; F02K 3/025; F05D 2300/10; F04D 29/321; F02W 2746/00164; F05D 2210/12; F05D 2220/32; F05D 2240/307; F04D 29/164

(57) ABSTRACT

A rotor system for a gas turbine engine may comprise a shrouded blade assembly. The shrouded blade assembly may include a blade configured to rotate about a central longitudinal axis of the gas turbine engine, an inner diameter shroud located at a proximal end of the blade, and a blade tip shroud located at a distal end of the blade. A radial seal assembly may be located radially outward of a distal surface of the blade tip shroud.

### FIELD

The present disclosure relates to gas turbine engines, and more specifically, to shrouded blade assemblies for gas turbine engines.

### BACKGROUND

Gas turbine engines typically include at least a compressor section to pressurize inflowing air, a combustor section to burn a fuel in the presence of the pressurized air, and a turbine section to extract energy from the resulting combustion gases. In the compressor section, compressed air may leak between the tips of the rotating blades and a structure radially outward of the blade tips, for example, an inner surface of an engine casing structure. Increasing pressure ratios of a high pressure compressor section of the gas turbine engine may lead to increased overall pressure ratios (OPR) and improved thermal efficiency, which may reduce fuel burn and increase thrust. However, increased pressure ratios can generate increased losses associated with leakage over the blade tips and recirculation of the core flow.

### SUMMARY

A rotor system for a gas turbine engine is disclosed herein. In accordance with various embodiments, the rotor system may comprise a shrouded blade assembly comprising a blade configured to rotate about a central longitudinal axis of the gas turbine engine, an inner diameter shroud located at a proximal end of the blade, and a blade tip shroud located at a distal end of the blade. A radial seal assembly may be located radially outward of a distal surface of the blade tip shroud.

In various embodiments, the radial seal assembly may comprise a non-contact radial seal. In various embodiments, the non-contact radial seal may comprise a shoe and a housing supporting the shoe. The shoe may be configured to translate towards the distal surface of the blade tip shroud in response to a pressure differential between a forward end of the shoe and an aft end of the shoe.

In various embodiments, a support structure may be located radially outward of the radial seal assembly. The housing may be contacting the support structure.

In various embodiments, the non-contact radial seal may be configured to maintain a predetermined clearance between a proximal edge of the shoe and the distal surface of the blade tip shroud. In various embodiments, the non-contact radial seal may be configured such that at the predetermined clearance an equilibrium is established preventing the shoe from translating radially inward.

In various embodiments, an axial length of the blade tip shroud may be greater than a chord of the blade. In various embodiments, the blade may be integral with the blade tip shroud.

A compressor for a gas turbine engine is also disclosed herein. In accordance with various embodiments, the compressor may comprise a shrouded blade assembly comprising a blade configured to rotate about an engine central longitudinal axis, and a blade tip shroud located at a distal end of the blade. A radial seal assembly may be located radially outward of the blade tip shroud. A stator vane assembly may be axially adjacent to the shrouded blade assembly.

In various embodiments, a compressor casing structure may house the shrouded blade assembly and the stator vane assembly. A support structure may be configured to couple the radial seal assembly and the stator vane assembly to the compressor casing structure.

In various embodiments, the radial seal assembly may comprise a non-contact radial seal. In various embodiments, the non-contact radial seal may comprise a shoe and a housing supporting the shoe. The shoe may be configured to translate towards a distal surface of the blade tip shroud in response to a pressure differential between a forward end of the shoe and an aft end of the shoe.

In various embodiments, the non-contact radial seal may be configured to maintain a predetermined clearance between a proximal edge of the shoe and the distal surface of the blade tip shroud. In various embodiments, the non-contact radial seal may be configured such that at the predetermined clearance an equilibrium is established preventing the shoe from translating radially inward.

In various embodiments, an axial length of the blade tip shroud may be greater than a chord of the blade.

Also disclosed herein is a gas turbine engine. In accordance with various embodiments, the gas turbine engine may comprise a compressor including a plurality of rotor systems. Each rotor system of the plurality of rotor systems may comprise a blade configured to rotate about a central longitudinal axis of the gas turbine engine, and a blade tip shroud located at a distal end of the blade. An axial length of blade tip shroud may be greater than a chord of the blade. A combustor may be located aft of the compressor.

In various embodiments, each rotor system of the plurality of rotor systems may further comprise a radial seal assembly located radially outward of the blade tip shroud.

In various embodiments, the radial seal assembly may comprise a non-contact radial seal configured to translate towards a distal surface of the blade tip shroud in response to a pressure differential between a forward end of the blade tip shroud and an aft end of the blade tip shroud. In various embodiments, the non-contact radial seal may be configured to maintain a predetermined clearance between a proximal edge of the non-contact radial seal and the distal surface of the blade tip shroud. In various embodiments, the blade tip shroud may be integral to the blade.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the figures, wherein like numerals denote like elements.

FIG. 1 illustrates a cross-section view of a gas turbine engine, in accordance with various embodiments;

FIG. 2 illustrates a cross-section view of a high pressure compressor section of a gas turbine engine, in accordance with various embodiments;

FIG. 3 illustrates a perspective view of shrouded blade assemblies, in accordance with various embodiments;

FIG. 4 illustrates a non-contact radial seal located radially outward of a shrouded blade, in accordance with various embodiments; and

FIG. 5 illustrates a fracturing of a shrouded blade, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the exemplary embodiments of the disclosure, it should be understood that other embodiments may be realized and that logical changes and adaptations in design and construction may be made in accordance with this disclosure and the teachings herein. Thus, the detailed description herein is presented for purposes of illustration only and not limitation. The steps recited in any of the method or process descriptions may be executed in any order and are not necessarily limited to the order presented.

Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. Additionally, any reference to without contact (or similar phrases) may also include reduced contact or minimal contact. Surface cross hatching lines may be used throughout the figures to denote different parts but not necessarily to denote the same or different materials.

Throughout the present disclosure, like reference numbers denote like elements. Accordingly, elements with like element numbering may be shown in the figures, but may not necessarily be repeated herein for the sake of clarity.

As used herein, “aft” refers to the direction associated with the tail (i.e., the back end) of an aircraft, or generally, to the direction of exhaust of the gas turbine. As used herein, “forward” refers to the direction associated with the nose (i.e., the front end) of an aircraft, or generally, to the direction of flight or motion. As used herein, “distal” refers to the direction radially outward, or generally, away from the central longitudinal axis of the gas turbine engine. As used herein, “proximal” refers to a direction radially inward, or generally, towards the central longitudinal axis of the gas turbine engine.

A first component that is “radially outward” of a second component means that the first component is positioned at a greater distance away from the engine central longitudinal axis than the second component. A first component that is “radially inward” of a second component means that the first component is positioned closer to the engine central longitudinal axis than the second component. In the case of components that rotate circumferentially about the engine central longitudinal axis, a first component that is radially inward of a second component rotates through a circumferentially shorter path than the second component. The terminology “radially outward” and “radially inward” may also be used relative to references other than the engine central longitudinal axis.

High pressure compressors of the present disclosure may include rotor systems having shrouded blade assemblies. Radial seal assemblies may be located radially outward of the shrouded blade assemblies. In various embodiments, the radial seal assemblies may comprise a non-contact radial seal. In this regard, a blade tip shroud of the shrouded blade assemblies may provide a radially inner land with which the non-contact radial seal interacts, but does not contact. A pressure differential across the radial seal assembly may allow the radial seal assembly to translate radially with the blade tip shroud, while maintaining a minimum clearance between the seal and the blade tip shroud. In this regard, the rotor systems disclosed herein may be associated with reduced leakage and increased efficiency, as compared to rotor systems employing labyrinth seals and/or abradable materials.

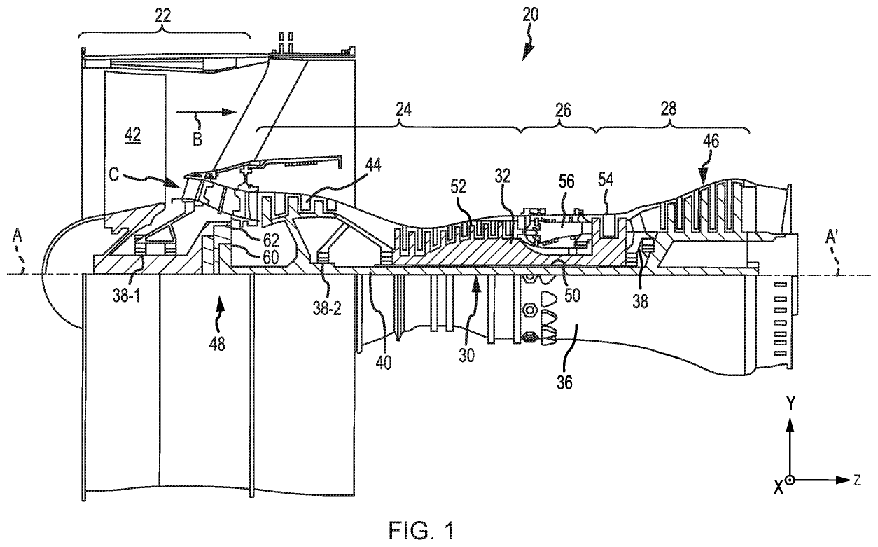

In various embodiments, and with reference to FIG. 1, a gas turbine engine 20 is disclosed. Gas turbine engine 20 may comprise a two-spool turbofan that generally incorporates a fan section 22, a compressor section 24, a combustor section 26, and a turbine section 28. In operation, fan section 22 may drive a fluid (e.g., air) along a bypass flow-path B, while compressor section 24 drives fluid along a core flow-path C for compression and communication into combustor section 26, and then expansion through turbine section 28. FIG. 1 provides a general understanding of the sections in a gas turbine engine, and is not intended to limit the disclosure. The present disclosure may extend to all types of applications and to all types of turbine engines, including, for example, turbojets, turboshafts, and engines including more or less than two spools.

In various embodiments, gas turbine engine 20 may comprise a low speed spool 30 and a high speed spool 32 mounted for rotation about an engine central longitudinal axis A-A′ relative to an engine static structure 36 via one or more bearing systems 38 (shown as, for example, bearing system 38-1 and bearing system 38-2 in FIG. 1). It should be understood that various bearing systems 38 at various locations may alternatively or additionally be provided, including, for example, bearing system 38, bearing system 38-1, and/or bearing system 38-2.

In various embodiments, low speed spool 30 may comprise an inner shaft 40 that interconnects a fan 42, a low pressure compressor section 44, and a low pressure turbine section 46. Inner shaft 40 may be connected to fan 42 through a geared architecture 48 that can drive fan 42 at a lower speed than low speed spool 30. Geared architecture 48 may comprise a gear assembly 60 enclosed within a gear housing 62. Gear assembly 60 may couple inner shaft 40 to a rotating fan structure. High speed spool 32 may comprise an outer shaft 50 that interconnects a high pressure compressor (“HPC”) 52 and high pressure turbine 54. A combustor 56 may be located between HPC 52 and high pressure turbine 54. Inner shaft 40 and outer shaft 50 may be concentric and may rotate via bearing systems 38 about engine central longitudinal axis A-A′. As used herein, a “high pressure” compressor and/or turbine may experience a higher pressure than a corresponding “low pressure” compressor and/or turbine.

In various embodiments, the air along core airflow C may be compressed by low pressure compressor 44 and HPC 52, mixed and burned with fuel in combustor 56, and expanded over high pressure turbine 54 and low pressure turbine 46. Low pressure turbine 46 and high pressure turbine 54 may rotationally drive low speed spool 30 and high speed spool 32, respectively, in response to the expansion.

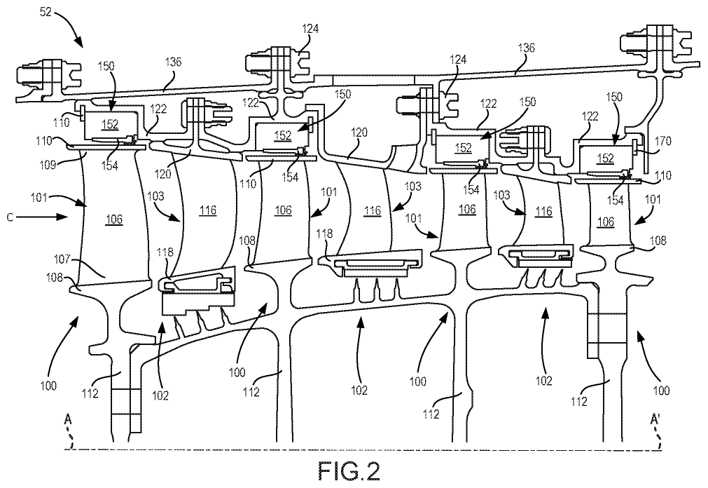

In various embodiments, and with reference to FIG. 2, a section of HPC 52 is depicted in greater detail. HPC 52 may include a plurality of rotating rotor systems (stages) 100 and a plurality of non-rotating stator systems (stages) 102 axially interspersed between the rotor systems 100. Rotor systems 100 may each comprise a shrouded blade assembly 101 configured to rotate about engine central longitudinal axis A-A′ and drive fluid along core flow-path C. Stator systems 102 may each comprise a vane assembly 103, which does not rotate relative to engine central longitudinal axis A-A′. Vane assemblies 103 may help direct the flow of fluid between shrouded blade assemblies 101.

Shrouded blade assemblies 101 may each comprise a plurality of blades 106 circumferentially spaced, and configured to rotate, about engine longitudinal axis A-A′. Blades 106 may be attached at a proximal (or first) end 107 to an inner diameter (ID) shroud 108, and at a distal (or second) end 109 to outer diameter (OD) shroud 110 (referred to herein as a blade tip shroud 110). ID shroud 108 may be radially spaced apart from blade tip shroud 110.

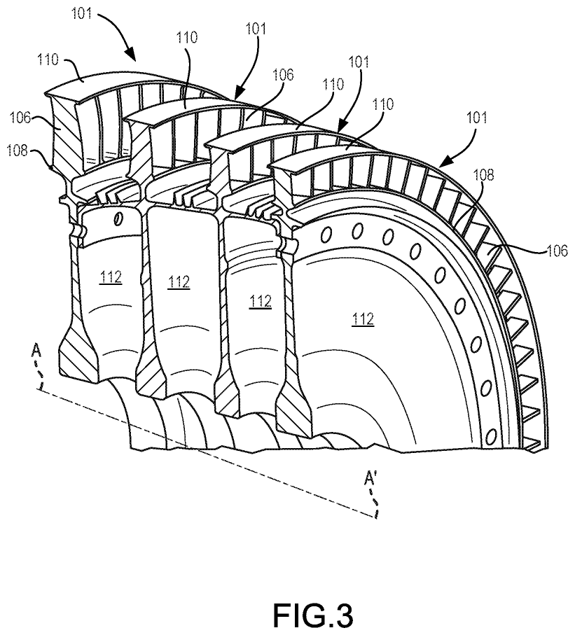

With reference to FIG. 3, a perspective view of shrouded blade assemblies 101 is illustrated, in accordance with various embodiments. Shrouded blade assemblies 101 may further include a rotor disk 112 configured to rotate about engine longitudinal axis A-A′. In various embodiments, ID shroud 108 and blade tip shroud 110 may be integral with blade 106. In various embodiments, ID shroud 108 may be integral with rotor disk 112. Stated differently, in various embodiments, shrouded blade assembly 101 may comprise a single component, wherein blades 106, ID shroud 108, blade tip shroud 110, and rotor disk 112 comprise a single manufactured (e.g., forged, die-cast, etc.) part. In various embodiments, shrouded rotor assembly 101 may comprise multiple components, wherein ID shroud 108 and blade tip shroud 110 are coupled, bonded, or otherwise fixed to blades 106 to form shrouded blade assembly 101. In various embodiments, blades 106, ID shroud 108, blade tip shroud 110, and rotor disk 112 may be comprised of a metal, including, but not limited to, nickel, chromium, aluminum, titanium, and steel. In various embodiments, blades 106, ID shroud 108, blade tip shroud 110, and rotor disk 112 may be comprised of a carbon composite material.

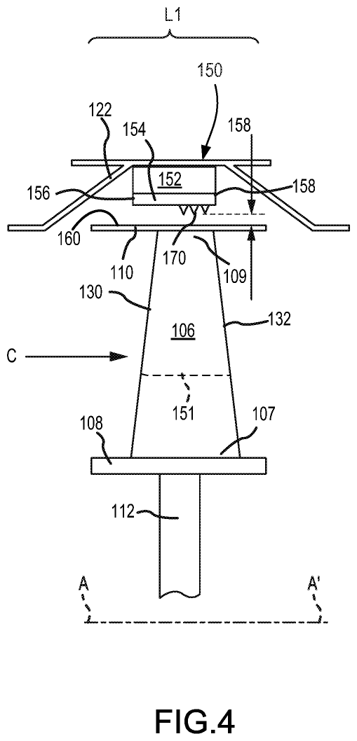

With momentary reference to FIG. 4. In various embodiments, an axial length L1 of blade tip shroud 110 is greater than a chord 151 of blade 106. Chord 151 represents and imaginary line extending from a leading edge 130 to a trailing edge 132 of blade 106.

Returning to FIG. 2, vane assemblies 103 may each include a plurality of stator vanes 116 circumferentially spaced about engine central longitudinal axis A-A′. Stator vanes 116 may extend between an ID platform 118 and an out diameter (OD) platform 120. Stator vanes 116 may be located axially between blades 106. Blades 106 may drive and/or create energy from the core airflow that is communicated along core flow-path C. Stator vanes 116 may direct the core airflow to blades 106. In various embodiments, blade tip shrouds 110 and OD platforms 120 may form a portion of an outer core engine structure, and ID shrouds 108 and ID platforms 118 may form a portion of an inner core engine structure to at least partially define an annular core gas flow path through HPC 52.

Although the present disclosure is directed to rotor systems and shrouded blade assemblies in HPC 52, it is further contemplated and understood that the rotor systems and shrouded blade assemblies disclosed herein may be equally applicable to blade stages in low pressure compressor 44, low pressure turbine 46, and/or other areas of gas turbine engine 20 (FIG. 1).

Each OD platform 120 may be coupled to a support structure 122. Support structure 122 may be coupled, for example via fasteners 124, to a HPC casing structure 136. In this regard, support structure 122 may support attachment of vane assemblies 103 to HPC casing structure 136. HPC casing structure may be locate around and may house rotor systems 100 and stator systems 102. In various embodiments, HPC casing structure 136 may form a portion of engine static structure 36, with momentary reference to FIG. 1.

In various embodiments, rotor systems 100 may each further include a radial seal assembly 150. Radial seal assembly 150 is located radially outward of shrouded blade assemblies 101. As discussed in further detail below, radial seal assembly 150 may reduce the flow or leakage of fluid over a distal surface 160 of blade tip shroud 110.

Radial seal assemblies 150 may include a housing 152 and a shoe 154. Housing 152 may generally support shoe 154. Housing 152 may be in contact with and coupled to support structure 122. Stated differently, support substructure 122 may support a coupling of radial seal assembly 150 to HPC casing structure 136. In various embodiments, a snap ring 156 may couple housing 152 to support structure 122. In various embodiments, housing 152 may be a ring or split ring structure. Shoe 154 may be formed by a plurality of arcuate segments. The arcuate segments are arranged circumferentially such that the arcuate segments form an annular structure spanning 360° about engine central longitudinal axis A-A′.

With reference to FIG. 4, shoe 154 may be spaced a clearance 158 from a distal surface 160 of blade tip shroud 110. In various embodiments, radial seal assembly 150 is configured such that as fluid moves aftward underneath shoe 154, (i.e. between shoe 154 and distal surface 160), it creates force, or suction, which causes radially inward (or proximal) edges 170 of shoe 154 to translate radially inward toward distal surface 160, thereby reducing clearance 158. Stated differently, a pressure drop is generated between a forward side 156 and an aft side 158 of shoe 154. The pressure differential generates a force which translates radially inward edges 170 of shoe 154 toward distal surface 160 of blade tip shroud 110. As the pressure differential increases, clearance 158 decreases. Radial seal assembly 150 is further configured such that a predetermined clearance 158, an equilibrium is established and shoe 154 will no longer translate radially inward toward distal surface 160 of blade tip shroud 110. In various embodiments, radial seal assembly 150 is configured such that the equilibrium is established at a clearance 158 distance of approximately 0.030 inches (˜0.762 mm). In various embodiments, equilibrium is established at a clearance 158 distance of approximately 0.010 inches (˜0.254 mm). In various embodiments, equilibrium is established at a clearance 158 distance of approximately 0.0035 inches (˜0.089 mm). As used in the previous context, approximately means ±0.001 inches (0.025 mm). In this regard, radial seal assembly 150 comprises a non-contact radial seal (i.e., a seal which restricts leakage over distal surface 160 of blade tip shroud 110, while reducing or preventing occurrences of contact between shoe 154 and distal surface 160 of blade tip shroud 110). The pressure differential and equilibrium act on shoe 154, such that shoe 154 will move radially with blade tip shroud 110, thereby maintaining clearance 158 and preventing or reducing a likelihood that distal surface 160 will contact shoe 154.

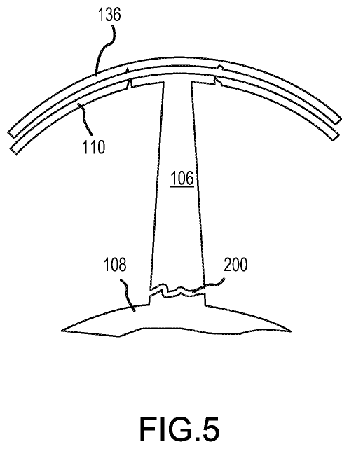

With reference to FIG. 5, shrouded blade assembly 101 is illustrated with a fracture 200 formed through blade 106. Fracture 200 may free blade 106 from ID shroud 108. However, blade 106 may remain attached to blade tip shroud 110. The attachment to blade tip shroud 110 may prevent blade 106 from traveling radially outward and damaging casing structure 136, and/or from traveling through the gas path and damaging downstream hardware.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosures is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A rotor system for a gas turbine engine, comprising:
a shrouded blade assembly comprising:
a blade configured to rotate about a central longitudinal axis of the gas turbine engine;
an inner diameter shroud located at a proximal end of the blade; and
a blade tip shroud located at a distal end of the blade; and
a radial seal assembly located radially outward of a distal surface of the blade tip shroud.

2. The rotor system of claim 1, wherein the radial seal assembly comprises a non-contact radial seal.

3. The rotor system of claim 2, wherein the non-contact radial seal comprises a shoe and a housing supporting the shoe, wherein the shoe is configured to translate towards the distal surface of the blade tip shroud in response to a pressure differential between a forward end of the shoe and an aft end of the shoe.

4. The rotor system of claim 3, wherein the non-contact radial seal is configured to maintain a predetermined clearance between a proximal edge of the shoe and the distal surface of the blade tip shroud.

5. The rotor system of claim 4, wherein the non-contact radial seal is configured such that at the predetermined clearance an equilibrium is established preventing the shoe from translating radially inward.

6. The rotor system of claim 3, further comprising a support structure located radially outward of the radial seal assembly, wherein the housing is contacting the support structure.

7. The rotor system of claim 1, wherein an axial length of the blade tip shroud is greater than a chord of the blade.

8. The rotor system of claim 7, wherein the blade is integral with the blade tip shroud.

9. A compressor for a gas turbine engine, comprising:
a shrouded blade assembly comprising:
a blade configured to rotate about an engine central longitudinal axis; and
a blade tip shroud located at a distal end of the blade;
a radial seal assembly located radially outward of the blade tip shroud; and
a stator vane assembly axially adjacent to the shrouded blade assembly.

10. The compressor of claim 9, further comprising:
a compressor casing structure housing the shrouded blade assembly and the stator vane assembly; and
a support structure configured to couple the radial seal assembly and the stator vane assembly to the compressor casing structure.

11. The compressor of claim 9, wherein the radial seal assembly comprises a non-contact radial seal.

12. The compressor of claim 11, wherein the non-contact radial seal comprises a shoe and a housing supporting the shoe, wherein the shoe is configured to translate towards a distal surface of the blade tip shroud in response to a pressure differential between a forward end of the shoe and an aft end of the shoe.

13. The compressor of claim 12, wherein the non-contact radial seal is configured to maintain a predetermined clearance between a proximal edge of the shoe and the distal surface of the blade tip shroud.

14. The compressor of claim 13, wherein the non-contact radial seal is configured such that at the predetermined clearance an equilibrium is established preventing the shoe from translating radially inward.

15. The compressor of claim 9, wherein an axial length of the blade tip shroud is greater than a chord of the blade.

16. A gas turbine engine, comprising:
a compressor including a plurality of rotor systems, wherein each rotor system of the plurality of rotor systems comprises:
a blade configured to rotate about a central longitudinal axis of the gas turbine engine; and
a blade tip shroud located at a distal end of the blade, wherein an axial length of blade tip shroud is greater than a chord of the blade; and
a combustor located aft of the compressor.

17. The gas turbine engine of claim 16, wherein each rotor system of the plurality of rotor systems further comprises a radial seal assembly located radially outward of the blade tip shroud.

18. The gas turbine engine of claim 17, wherein the radial seal assembly comprises a non-contact radial seal configured to translate towards a distal surface of the blade tip shroud in response to a pressure differential between a forward end of the blade tip shroud and an aft end of the blade tip shroud.

19. The gas turbine engine of claim 18, wherein the non-contact radial seal is configured to maintain a predetermined clearance between a proximal edge of the non-contact radial seal and the distal surface of the blade tip shroud.

20. The gas turbine engine of claim 17, wherein the blade tip shroud is integral to the blade.
